(19) United States
(12) Patent Application Publication
(10) Pub. No.: US 2018/0059402 A1
(43) Pub. Date: Mar. 1, 2018

(54) TUNABLE DIFFRACTION GRATING

(71) Applicant: Honeywell International Inc., Morris Plains, NJ (US)

(72) Inventors: Ryan Jung, Blaine, MN (US); Emily Hellerich, Minnetonka, MN (US)

(21) Appl. No.: 15/247,307

(22) Filed: Aug. 25, 2016

(51) Int. Cl. G02B 26/00; G02B 5/18

(52) U.S. Cl. CPC G02B 26/004; G02B 5/1861; G02B 5/1828

(57) ABSTRACT

Devices, methods, systems, and computer-readable media for a tunable diffraction grating are described herein. One or more embodiments include a tunable diffraction grating having an electromagnetic array and a ferrofluid positioned proximate to the electromagnetic array and positioned to receive and reflect a beam of radiation.

### TECHNICAL FIELD

The present disclosure relates to methods, devices, systems, and computer-readable media for a tunable diffraction grating.

### BACKGROUND

Diffraction gratings, either transmissive or reflective, can separate different wavelengths of electromagnetic radiation using a structure formed in a surface of the grating. Gratings are commonly used in the visible light and ultraviolet electromagnetic wavelength ranges, but can be used in any desired range within the electromagnetic spectrum. The structure of the grating affects the amplitude and/or phase of the incident wave (a wave directed to hit the surface of the grating), causing interference in the output wave (a wave that is reflected off the surface of the grating or as a result of the wave passing through the grating and having a changed direction due to its interaction with the grating).

A reflection grating has its patterned surface coated with a reflective material, typically a metallic material, to enhance reflectivity. Transmission gratings do not have a reflective coating as the incident light is diffracted upon transmission through the grating material.

For non-tunable gratings, the grating material is a solid substrate of material and the pattern is etched or molded into the surface creating a fixed grating surface structure. Gratings used to disperse ultraviolet (UV) and visible light usually contain between 300 and 3000 grooves per millimeter, so the distance between adjacent grooves is on the order of one micron.

Tunable gratings typically use an elastomeric sheet of material that has a multiple electromagnetic components attached at different places on one of the elongate side surfaces of the elastomeric material. These electromagnetic components can then be selectively energized to change the shape of the other elongate side surface of the elastomeric sheet of material which is used as the diffraction grating. However, due to the small size of the grating structure, the cost of fabrication of such systems is high and involves many moving parts which may fail during use.

### BRIEF DESCRIPTION OF THE DRAWINGS

FIG. 1 is an example of a system for a tunable diffraction grating wherein the surface of the grating is in a first state according to one or more embodiments of the present disclosure.

FIG. 2 is an example of a system for a tunable diffraction grating wherein the surface of the grating is in a second state according to one or more embodiments of the present disclosure.

FIG. 3 is an example of a diagram of a computing device for a tunable diffraction grating according to one or more embodiments of the present disclosure.

### DETAILED DESCRIPTION

Ferrofluids are colloidal liquids made of ferromagnetic particles suspended in a carrier fluid (usually a viscous liquid such as liquids derived from petroleum, plant, animal or mineral sources, like oil, or liquids such as organic solvents, or water). For use with respect to the present disclosure, the term ferrofluids used herein includes both: fluids having nanoparticles and fluids having larger particle sizes, commonly referred to as magnetorheological fluids, which may also be suitable in some applications.

Ferrofluids are magnetic and when a magnetic field is applied near the fluid, the fluid moves based on its interaction with the field and can make various shapes. The shapes can be altered based on the magnetic field applied. As discussed herein, a technique for forming various shapes can be applied to form shapes suitable for use as a diffraction grating.

Accordingly, devices, methods, systems, and computer-readable media for a tunable diffraction grating are described herein. For example, one or more embodiments include a tunable diffraction grating having an electromagnetic array and a ferrofluid positioned proximate to the electromagnetic array and positioned to receive and reflect a beam of radiation. Such embodiments allow the formation of a diffraction grating shape to be formed without the use of elastomeric or solid sheets of material and the various issues such constructions present.

Provided below is a discussion of various embodiments that may be utilized in view of the information provided in the present disclosure. In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit corresponds to the drawing figure number and the remaining digits identify an element or component in the drawing. Similar elements or components between different figures may be identified by the use of similar remaining digits.

As used herein, “a” or “a number of” something can refer to one or more such things. For example, “a number of devices” can refer to one or more devices. Additionally, the designator “N”, as used herein, particularly with respect to reference numerals in the drawings, indicates that a number of the particular feature so designated can be included with a number of embodiments of the present disclosure.

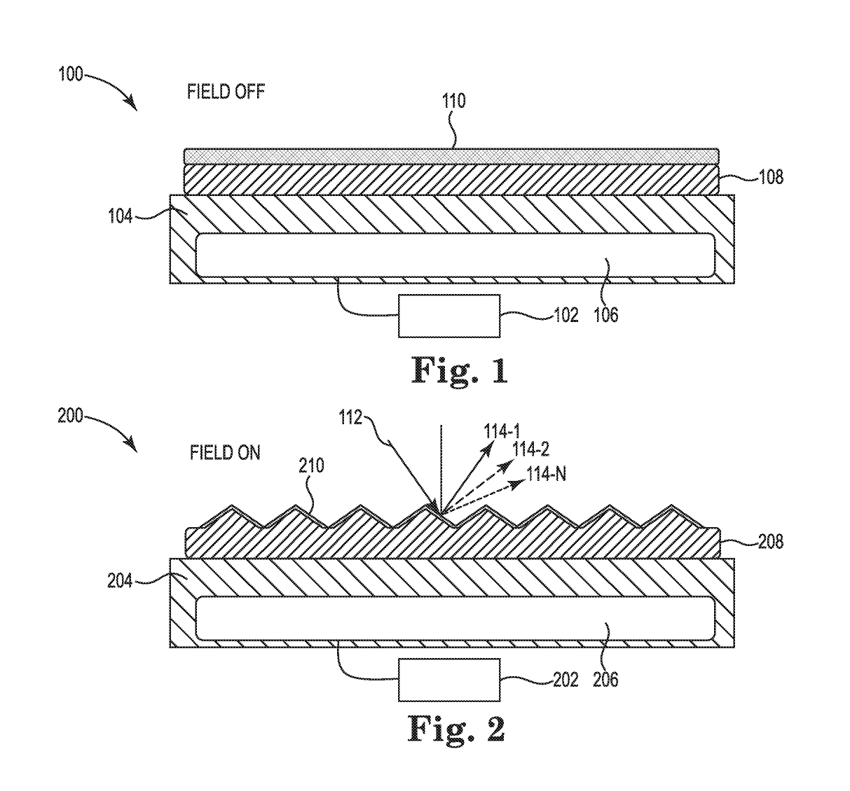

FIG. 1 is an example of a system for a tunable diffraction grating wherein the surface of the grating is in a first state according to one or more embodiments of the present disclosure FIG. 1 illustrates a system for a tunable diffraction grating 100 having a controller 102, a substrate 104 having an electromagnetic array 106 formed therein or thereon, a ferrofluid in a housing 108, and a reflective material 110.

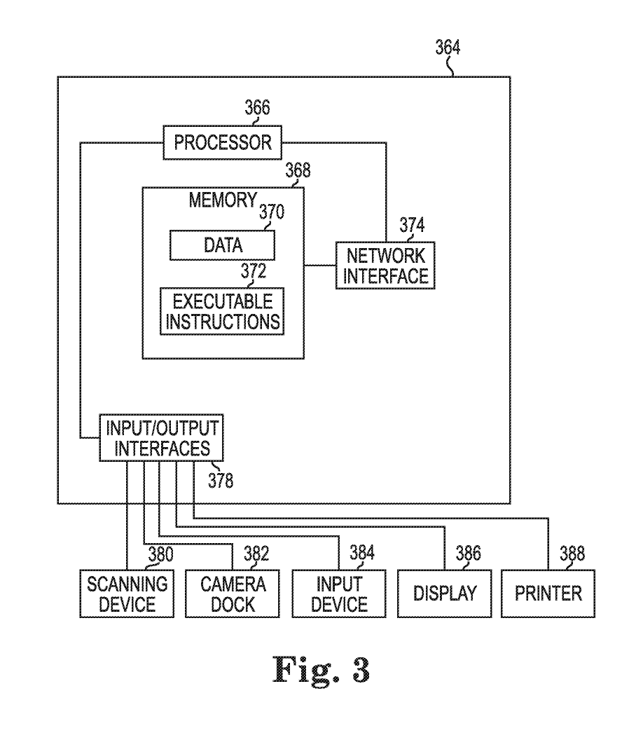

The controller 102 is used to actuate the elements of the electromagnetic array 106. As described below, in some embodiments, the controller 102 can receive instructions from a computing device or can be a computing device, for example, as described with respect to FIG. 3.

In various embodiments, the controller can determine which elements in the electromagnetic array are actuated (turned on) and/or, in some embodiments, determine the amount of electromagnetic energy each element produces. Further, in some embodiments, the controller controls groups of elements rather than individual elements, for example, a row of elements arranged in a matrix having rows and columns of elements can all be controlled together to generate an elongate wave form along the row of actuated elements.

In the embodiment illustrated in FIGS. 1 and 2, the ferrofluid is housed in a flexible housing allowing the ferrofluid to be maintained in position proximate to the electromagnetic array 104, but still allow a surface of the ferrofluid (in the example, the top surface of the ferrofluid) to change shape to create the shaped diffraction grating surface.

In some embodiments, one or more of the other surfaces (not the surface that forms the shaped diffraction grating surface) of the housing can be rigid (e.g., side and/or bottom surfaces of the housing). This can also allow the ferrofluid to be maintained in position and allow a surface of the ferrofluid to change shape to form the shaped surface of the diffraction grating.

The ferrofluid or the housing of the ferrofluid can be positioned on a surface of an array of electromagnetic elements or a substrate having the array therein. When using a substrate, it is preferred that the substrate be substantially transparent to electromagnetic energy created by the electromagnetic array elements thereby allowing the energy to interact with the ferrofluid to change its state (e.g., between a state where the electromagnetic field is off resulting in a generally planar surface as shown in FIG. 1 and a state where the electromagnetic field is on resulting in a non-planar surface as shown in FIG. 2).

The embodiment of FIGS. 1 and 2 show the use of a reflective material 110 on the ferrofluid housing 108. This material can be placed on the surface of a housing, directly onto or in the ferrofluid itself, or the system can be utilized without a reflective coating, instead relying on the reflectivity of the material of the housing and/or the reflectivity of the ferrofluid.

Embodiments of the present disclosure can keep a reflective surface of the ferrofluid (either the fluid itself, the reflective material that has been added, and/or the reflective housing material) at a predetermined location when an electromagnetic field generated by the electromagnetic array is off. Similarly, some embodiments can hold the ferrofluid in position when the electromagnetic array is on (i.e., at least one element of the array is on). This can be beneficial in directing reflected radiation to the desired direction after reflection.

The reflective material can be any suitable type of material for reflective radiation of the surface of the diffraction grating. Suitable examples of reflective surfaces can be a sheet of material positioned on a surface of the ferrofluid, a portion of a housing to keep the ferrofluid in a position proximate to the electromagnetic array, and/or material formed from a number of reflective particles positioned on a surface of the ferrofluid or in the ferrofluid.

FIG. 2 is an example of a system for a tunable diffraction grating wherein the surface of the grating is in a second state according to one or more embodiments of the present disclosure. In the embodiment of FIG. 2, when an electromagnetic field is applied through the substrate 204 via the electromagnetic array 206, the ferrofluid 208 responds by changing shape. In this example, the shape, when viewed in two dimensions, is a sawtooth shape.

Depending on the arrangement of the elements of the electromagnetic array and their actuation, the three dimensional shape of this example could be a series of long parallel waves each having a sawtooth peak at the top of the wave or could be a complex arrangement of pyramid shaped waves having a sawtooth profile when viewed in two dimensions. Another shape that can be made is a curved wavetop form, where the tops of the waves are curved instead of pointed. One suitable example of this waveform is a sinusoidal pattern.

In some embodiments, the controller 202 can actuate the electromagnetic array in a manner to change the shape of the surface of the ferrofluid from the linear shape shown in FIG. 1 to at least one of a sinusoidal wave shape and a sawtooth wave shape, as viewed in two dimensions. As discussed above, the resultant two dimensional shapes described herein can result from multiple three dimensional shapes depending on the three dimensional shape desired.

In some embodiments, if a series of parallel waves is desired, the array may have elements that are arranged in a series of elongated parallel paths (along axes that are perpendicular to the horizontal and vertical axes defining the shapes of the waves of FIG. 2). In such embodiments, only parallel waves can be formed.

However, in some such embodiments, depending on the type of element provided in the array, the shape of the wave form can be different. For example, one type of element may be used to form the sawtooth type wave form and another type of element can be used to form the curved wave form. In some such embodiments, it may be possible to have a mix of such elements thereby allowing the use of sawtooth and curved wave forms at different locations.

Further, in some embodiments, the wave form type can be changed based on a change in the magnitude of electromagnetic energy produced by an element. For example, a lower amount of energy may produce a curved shaped wave form and a higher amount of energy may produce a sawtooth wave form.

Additionally, in some such series of parallel element embodiments, the controller 202 may be designed to allow for the elements to be selectively turned on and off, thereby allowing the frequency of the wave form to be changed. For example, every other element could be turned on thereby decreasing the frequency to half that of a wave form made when all elements are turned on (e.g., element 1 on, element 2 off, element 3 on, element 4 off, . . . ). Such changes to the frequency will also change the pitch of the side surfaces of the wave between the peak and trough of the wave. Further, an adjustment of the frequency will also change the wavelength of a series of waves.

Such a change is illustrated in FIG. 2, wherein a beam of radiation (e.g., beam of visible, IR, UV, or other light, etc.) 112 reflects off the reflective surface 110 of the system 100. The direction of the reflected light can be changed based on its angular interaction with the reflective surface and, in some respects, based on the properties of the reflective surface. For example, if the pitch of the surface 108 is changed, the direction of the reflected radiation can be directed in direction 114-1, 114-2, or 114-N.

Further, in some such embodiments, the controller can create different frequencies along different portions of the ferrofluid by turning on different elements. For example, in one portion, all elements can be actuated. In another portion every other element can be actuated, and in yet another portion every another pattern of elements could be actuated (e.g., every third, every fourth, etc.). It should be noted that in some embodiments, it is possible to create a single wave rather than a series of waves as shown in FIG. 2.

In other embodiments, the array may include a matrix of elements that each can be independently actuated to form more complex wave shapes such as pyramid shapes and dome shapes. In such an embodiment, the elements could be arranged in a matrix having a length dimension and a width dimension, like the squares on a checker board.

In such embodiments, each element (a square on the checkerboard pattern) can be actuated independently of the others, thereby creating a unique shape in the ferrofluid interacting with that element. Similarly, with respect to the discussion above, the use of different types of elements or energies provided by the elements could be used in multiple different areas of the array to provide a very diverse number of wave form combinations, however, herein the wave forms can have three dimensions, such as pyramids and domes.

Additionally, in some embodiments, a single three dimensional shape can be created by actuating a single element (one square on the checkerboard pattern. And, although the example of square elements is used herein, the elements can have other shapes provided in a matrix. For example, the elements can have a circular, oval, or irregular shape, in some embodiments.

FIG. 3 is an example of a diagram of a computing device 330 for a tunable diffraction grating according to one or more embodiments of the present disclosure. FIG. 3 illustrates an example computing device readable medium having executable instructions that can be executed by a processor to perform a method, such as for the design of the shape to be produced on the surface of the ferrofluid that forms the tunable diffraction grating or to control the formation of that surface, among other functions, according to one or more embodiments of the present disclosure. In order to accomplish some functions described herein, in some implementations, a computing device 364 can have a number of components coupled thereto which will be described in more detail below.

In the example shown in FIG. 3, the computing device 364 can include a processor 366 and a memory 368. The memory 368 can have various types of information including data 370 and executable instructions 372, as discussed herein.

The processor 366 can execute instructions 372 that are stored on an internal or external non-transitory computer device readable medium (CRM). A non-transitory CRM, as used herein, can include volatile and/or non-volatile memory. Volatile memory can include memory that depends upon power to store information, such as various types of dynamic random access memory (DRAM), among others. Non-volatile memory can include memory that does not depend upon power to store information.

Memory can be used, for example, to hold instructions and/or data for the formation of one or more diffraction grating shapes on a surface of the ferrofluid. Memory can also, or alternatively, be used to store instructions and/or data for designing the shapes of the tunable diffraction grating. For instance, such information can include actuation instructions for one or more locations on the electromagnetic array and/or power quantities for one or more specific locations on the electromagnetic array.

Memory 368 and/or the processor 366 may be located on the computing device 364 or off the computing device 364, in some embodiments. As such, as illustrated in the embodiment of FIG. 3, the computing device 364 can include a network interface 374. Such an interface 374 can allow for processing on another networked computing device, can be used to obtain information about the formation and/or design of the tunable diffraction grating, and/or can be used to obtain data and/or executable instructions for use with various embodiments provided herein.

As illustrated in the embodiment of FIG. 3, the computing device 364 can include one or more input and/or output interfaces 378. Such interfaces 378 can be used to connect the computing device 364 with one or more input and/or output devices 380, 382, 384, 386, 388.

For example, in the embodiment illustrated in FIG. 3, the input and/or output devices can include a scanning device 380, a camera dock 382, an input device 384 (e.g., a mouse, a keyboard, etc.), a display device 386 (e.g., a monitor), a printer 388, and/or one or more other input devices. The input/output interfaces 378 can receive executable instructions and/or data, storable in the data storage device (e.g., memory), utilized in formation and/or design of the tunable diffraction grating.

The processor 366 can execute instructions to actuate one or more locations of the electromagnetic array, monitor the interaction between the diffraction grating and the beam of radiation contacting the grating, display information on the display device 386 for review by a user, respond to input from the various devices described above that provide input to the computing device 364.

Such connectivity can allow for the input and/or output of data and/or instructions among other types of information. Some embodiments may be distributed among various computing devices within one or more networks, and such systems as illustrated in FIG. 3 can be beneficial in allowing for the capture, calculation, and/or analysis of information, for example, to improve the tunability of the diffraction grating, calibrate the system to direct beams of radiation to the correct location, or troubleshoot problems with the ferrofluid or the system itself.

The processor 366, in association with the data storage device (e.g., memory 368), can be associated with the data 370. The processor 366, in association with the memory 368, can store and/or utilize data 370 and/or execute instructions 372 for determining a shape of a diffraction grating that can be formed on the surface of the ferrofluid. Such data can include a virtual model of the diffraction grating at one point in time or over various periods of time. The virtual model of the diffraction grating with the specialized shape can be used to create a physical diffraction grating, for instance, as discussed further herein.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A tunable diffraction grating, comprising:
an electromagnetic array; and
a ferrofluid positioned proximate to the electromagnetic array and positioned to receive and reflect a beam of radiation.

2. The system of claim 1, wherein the ferrofluid is held within a housing to keep a reflective surface of the ferrofluid at a predetermined location when an electromagnetic field generated by the electromagnetic array is off.

3. The system of claim 1, wherein the ferrofluid is held within a housing to keep a reflective surface of the ferrofluid at a predetermined location when an electromagnetic field generated by the electromagnetic array is on.

4. The system of claim 1, wherein the housing is a flexible container that allows the shape of the housing to change with the shape of the ferrofluid held within the housing.

5. The system of claim 1, wherein the electromagnetic array is composed of a plurality of electromagnetic elements that can be independently actuated between an off state to an on state.

6. The system of claim 5, wherein a computing device can be in communication with the elements of the electromagnetic array to actuate the elements independently between the off state and the on state.

7. The system of claim 1, wherein the magnitude of electromagnetic energy provided by each element of the electromagnetic array is controlled by a controller.

8. The system of claim 1, wherein the electromagnetic array can be actuated in a manner to create a sinusoidal wave shape on a surface of the ferrofluid.

9. The system of claim 1, wherein the electromagnetic array can be actuated in a manner to create a sawtooth wave shape on a surface of the ferrofluid.

10. A tunable diffraction grating system, comprising:
a controller;
an electromagnetic array; and
a ferrofluid positioned proximate to the electromagnetic array.

11. The system of claim 10, wherein the electromagnetic array contains a plurality of independently actuate-able elements and wherein the elements can be actuated to change the pitch of a portion of surface of the ferrofluid.

12. The system of claim 10, wherein the electromagnetic array contains a plurality of independently actuate-able elements and wherein the elements can be actuated to change the frequency of a portion of surface of the ferrofluid.

13. The system of claim 10, wherein the electromagnetic array contains a plurality of independently actuate-able elements and wherein the elements can be actuated to change the wavelength of a portion of surface of the ferrofluid.

14. The system of claim 10, wherein the electromagnetic array can be actuated in a manner to change a shape of a surface of the ferrofluid from a linear shape in two dimensions to at least one of a sinusoidal wave shape and a sawtooth wave shape.

15. The system of claim 10, wherein the electromagnetic array can be actuated in a manner to change a shape of a surface of the ferrofluid between a sinusoidal wave shape and a sawtooth wave shape in two dimensions.

16. The system of claim 10, wherein the electromagnetic array can be actuated in a manner to change a shape of multiple areas on a surface of the ferrofluid from a linear shape in two dimensions to at least one of a sinusoidal wave shape and a sawtooth wave shape.

17. A tunable diffraction grating system, comprising:
a controller;
an electromagnetic array;
a ferrofluid positioned proximate to the electromagnetic array; and
a reflective layer of material positioned to receive and reflect a beam of radiation.

18. The system of claim 17, wherein the reflective layer of material is a sheet of material positioned on a surface of the ferrofluid.

19. The system of claim 17, wherein the reflective layer of material is a portion of a housing to keep the ferrofluid in a position proximate to the electromagnetic array.

20. The system of claim 17, wherein the reflective layer of material is formed from a number of reflective particles positioned on a surface of the ferrofluid.
